(19) United States
(12) Patent Application Publication
(10) Pub. No.: US 2025/0207035 A1
(43) Pub. Date: Jun. 26, 2025

(54) INTEGRATED PROCESS FOR THE CONVERSION OF PLASTIC WASTE

(71) Applicant: LATENT ENERGY LTD., Tel Aviv (IL)

(72) Inventors: Maurice ARTOUL, Tel Aviv (IL); Uri GIVAN, Tel Aviv (IL); Netta MENTOVICH, Tel Aviv (IL)

(21) Appl. No.: 18/848,974

(22) PCT Filed: Mar. 22, 2023
(86) PCT No.: PCT/IL2023/050302

§ 371 Date: Sep. 20, 2024

Related U.S. Application Data
(60) Provisional application No. 63/269,736, filed on Mar. 22, 2022.

(51) Int. Cl. C10G 1/10; C10G 1/00

(52) U.S. Cl. CPC C10G 1/10; C10G 1/002; C10G 2300/1003; C10G 2300/1011; C10G 2400/26

(57) ABSTRACT

The invention provides a system and a process for converting plastic waste materials into high value products.

### TECHNOLOGICAL FIELD

The invention generally contemplates an integrated process for the conversion of mixed plastic and/or biomass and metal-containing waste to high value products.

### BACKGROUND OF THE INVENTION

A steady increase in plastic material wastage has encouraged development of modern technologies that effectively convert the plastic into reusable materials. Plastic waste recycling is carried out in different ways, but in most developing countries, waste incineration and open or landfill disposal are common practices for plastic waste management.

Pyrolysis, a common technique used to convert plastic materials into liquid oils, is the thermal degradation of plastic waste at different temperatures (300-900° C.), in the absence of oxygen. Different kinds of catalysts are typically used to improve the pyrolysis process and to enhance process efficiency. While unlike mechanical processing, chemical recycling can be used to treat waste of complex materials—such as multilayered flexible packaging, metal-containing waste, biomass waste and so forth—all presently available thermochemical recycling processes suffer from two main disadvantages: the first being the need for high energy intensity and the second—the presence of essential auxiliary infrastructure and materials (e.g., hydrogen gas) required for product stream upgrading.

Many plastic decomposition systems have been developed for plastic chemical recycling; however, all rely on either external fossil energy resources or combustion of about 10-20% of the decomposition products as an energy source for decomposition and upgrading process, both involving significant direct greenhouse gas (GhG) emissions.

### GENERAL DESCRIPTION

The inventors of the technology disclosed herein have developed an integrated process, which not only overcomes many of the disadvantages associated with thermochemical processing of plastic materials, but also offers inherent product upgrading. In most general terms, in a system and a process according to the invention energy harnessed through an exothermic hydrogen production from metal-containing waste material feedstock is used in a thermochemical decomposition of a different waste material. As such, systems and processes of the invention provide an alternative to existing thermochemical decomposition reactions in providing:
1) An integrated process for the conversion of mixed plastic and metal containing waste to high value products, in an integrated process involving a hydro-processing reactor that provides simultaneous thermochemical decomposition and hydrogenation/hydrocracking/hydrothermal liquification of mixed plastic wastes where both heat and hydrogen requirements are met by coupling to a high temperature aluminum water reactor;
2) A scalable, commercially viable, high yield plastic thermochemical recuperation process that provides high value fuels/feedstock chemicals;
3) Process yield intensification via utilization of waste-grade aluminum reaction with water to provide hydrogen gas and energy required for high quality product production by the endothermic decomposition of plastic;
4) An in-situ generation of hydrogen gas, thereby eliminating the need for hydrocracking utilizing external source of the gas;
5) A sufficient amount of hydrogen gas is generated to maintain a hydrogen atmosphere to minimize coking;
6) A process requiring no catalysts, but may use commercially available catalysts for controlling various side reactions;
7) Recovery and upcycling of waste-grade metals such as aluminum;
8) Enhanced process unit scalability due to direct heat transfer; and
9) Enhanced process (thermal) efficiency and selectivity in the hydrothermal decomposition pathway.

Thus, in most general terms, there is provided an integrated system for generating distillates (as well as flammable gases, fuels, petrochemical products and oils) from a waste plastic material (or for converting mixed plastic waste to high value products), the system comprising a thermochemical reactor configured to cause thermochemical decomposition (e.g., including hydrogenation, hydrocracking, and/or hydrothermal liquefaction) of a sorted or unsorted plastic waste, wherein the thermochemical reactor is coupled or associated to a hydro-processing metal-water reactor that is configured and operable to generate thermal energy (heat), gaseous and other products, and hydrogen gas that is fully or partially harvested for carrying out the thermochemical decomposition in the thermochemical reactor. Thus, in some configuration, a system of the invention may be a closed loop system whereby hydrogen gas produced in one reactor is used in another reactor to produce high value products which may thereafter be separated and stored. While each of the reactors may be operable under different conditions in treating different batches of selection of waste materials, the harvesting of energy, e.g., by way of thermal energy, reactive materials such as hydrogen gas and steam, as well as heated molten plastic decomposition products, allow for effective energy harvesting and efficient production of products without needing to introducing external hydrogen gas to the system.

As used herein, the “thermochemical reactor” or ‘thermochemical decomposition reactor’ is a reactor of the system in which thermochemical decomposition of the waste materials occurs in the presence of hydrogen gas, or a mixture of hydrogen and steam, as well as molten plastic and other gaseous materials received directly or indirectly from the hydro-processing metal-water reactor, as further disclosed herein. The term “thermochemical decomposition” refers to a reaction in which hydrocarbons present in the waste material are converted, under high temperatures and in absence of oxygen, into one or more other materials or distillates (thermochemical recycling). The decomposition reaction or chemical transformation encompasses reactions such as pyrolysis, hydrocracking, hydropyrolysis, hydrothermal liquefaction processes, and other related reactions, as known in the art.

The “hydro-processing metal-water reactor” also referred to as a ‘hydrogen gas reactor or generator’ is a reactor of the system in which hydrogen production occurs from a reaction between a metal and plastic in the presence of water. In the process, in addition to hydrogen gas, steam, molten plastic, plastic decomposition vapors (various gaseous materials), and potentially also metal oxides are generated. Each of these may be separately or in combination with another product used as energy carriers to drive the thermochemical decomposition in the thermochemical reactor.

The term “waste plastic” refers to any waste material comprising an amount of a plastic material, namely any synthetic or semisynthetic polymerization product, generally a hydrocarbon-based polymer. A waste plastic stream may contain also biomass and other synthetic, semisynthetic or naturally occurring polymeric materials. Typically, the waste plastic material is a mixture of materials comprising polyethylene (such as low-density or high-density polyethylene) and/or polypropylene. In some cases, the waste may further comprise PVC, polystyrene and PET, or the waste may be free of PVC.

The waste plastic may be derived from any waste source including industrial and municipal waste. The waste may comprise a single polymeric or plastic component or a combination of components, may be presorted or used as is without any pretreatment or sorting of any type. The waste may comprise 2-dimensional or 3-dimensional plastic objects or materials which may be mechanically treated to reduce their size, e.g., by shredding or crushing, or may be used as is.

The waste plastic may or may not comprise metallic components or metals in general. The plastic waste may comprise metal waste and/or plastic materials which contain metals as additives or otherwise as separate waste components. In some configurations, the waste material comprises both plastic and metallic or metallic-plastic objects or materials, which may be presorted into two separate waste feedstocks: a plastic waste feedstock that is substantially free of metallic components (namely being metal-free, as further defined herein) and a metal-rich plastic waste feedstock. Where the waste contains less than needed zero-valet metal-rich products, the waste may be enriched with metal-rich products which are themselves waste or low-grade materials. The waste materials used may contain or include unrecycled or unrecyclable materials.

As disclosed herein, products obtained by thermochemical decompositions, under the conditions disclosed herein, include a variety of non-plastic end products or “distillates”, such as a variety of petrochemicals, fuels, naphtha, monomers and others. Each of these materials may be distilled or separated from the product distillates obtained by employing suitable isolation and/or purification techniques. The term “non-plastic” when made in reference to end products or other materials present in the waste materials, refers to any material that is not a hydrocarbon-based polymer, irrespective of its source.

While systems and processes of the invention find great environmental importance in converting waste plastics into high end products, processes of the invention may be similarly used for the conversion of any plastic material.

Thus, in a first of its aspects the invention provides an integrated system for thermochemical recycling of plastic materials, e.g., waste plastic, the system comprising a hydrotreating reactor or a hydrogen gas generator and a thermochemical reactor, each independently being configured to receive a plastic waste material, wherein hydrogen gas and thermal energy generated in the hydrotreating reactor is harvested for carrying out a thermochemical decomposition of plastic waste in the thermochemical reactor.

A system of the invention comprises:
a first vessel (reactor) configured for receiving a metal-rich plastic waste (or a combination of metal and plastic) and hydrotreating (thermally treating the waste in the presence of water) the metal-rich plastic waste (or combination) to produce hydrogen gas (and a decomposed plastic mass, steam and gaseous products, as well as metal oxides);
a second vessel (reactor) configured for receiving a plastic waste (optionally together or in combination with biomass, virgin plastic and/or non-waste plastic) and thermally decomposing the plastic waste (or a combination therewith) in the presence of at least the hydrogen gas generated in the first vessel, to produce plastic decomposition products (or distillates); and
means to direct hydrogen gas and optionally other heated materials from the first vessel to the second vessel.

Also provided is a system for thermochemical recycling of plastic materials, e.g., waste plastic, the system comprising
a first vessel (reactor) configured for receiving a metal-rich plastic waste and thermally treating the waste in the presence of water to produce hydrogen gas, steam and a decomposed plastic mass or gaseous products;
a second vessel (reactor) configured for receiving a plastic waste and thermally decomposing the plastic waste in the presence of the hydrogen gas and optionally the decomposed plastic mass and gaseous products produced in the first vessel, to produce plastic decomposition products (or distillates); and
means to direct hydrogen gas and optionally a heated decomposed plastic mass and gaseous products from the first vessel to the second vessel.

In some embodiments, the first vessel (reactor) is provided as two or more reactors each configured to receive a different component of the metal-rich plastic waste. In some embodiments, one of the reactors is configured to receive and thermally convert plastic waste to a molten plastic and gaseous products, e.g., without substantially causing decomposition of the plastic; and another of the reactors is configured to receive metal waste and water and configured and operable to generate hydrogen gas. The second vessel may thus be configured to receive a stream of molten plastic and gaseous products and a separate stream of hydrogen gas and steam.

In some embodiments, the system thus comprises
a vessel (reactor) arrangement comprising two or more reactors, one of said reactors being configured for receiving a metal-free plastic waste and thermally treating the metal-free plastic waste to produce a molten plastic mass and gaseous products; and a second of said reactors being configured to receive a metal waste and hydrotreat the metal waste to generate hydrogen gas and steam (and energy in the form of heat);
a second vessel (reactor) configured for receiving a plastic waste (optionally together or in combination with biomass, virgin plastic or non-waste plastic) and operable to cause thermal decomposing the plastic waste (or a combination therewith) in the presence of the hydrogen gas and optionally the molten plastic mass and gaseous products, to produce plastic decomposition products (or distillates); and
means to direct hydrogen gas and optionally a heated decomposed plastic mass from the first vessel to the second vessel.

In some embodiments, the system further comprises or is connected to or associated with a metal-rich plastic waste stream configured to deliver a metal-rich plastic waste feedstock into the first vessel.

In some embodiments, a metal-rich plastic stream is treated to separate the metal components from the plastic materials. In such cases, the system may comprise or be connected to or associated with two independent streams of metal and plastic (separated from a metal-rich source or from two separate waste sources: one metallic and the other plastic).

In some embodiments, the system further comprises or is associated with a plastic waste stream configured to deliver a plastic waste feedstock into the second vessel.

In some embodiments, the plastic waste stream is combined with a stream or an amount of a biomass material.

The invention further provides a system for a continuous thermochemical conversion of a plastic waste into distillates (and other decomposition byproducts), the system comprising
a vessel configured for receiving and hydrotreating a metal-rich waste material for converting same to hydrogen gas, steam and a heated decomposed plastic mass and gaseous products as disclosed herein,
the vessel being equipped with or associated to a thermochemical reactor configured for receiving the hydrogen gas, the heated decomposed plastic mass and a metal-free plastic waste, to cause thermochemical decomposition of the metal-free (or substantially free) plastic waste.

Further provided is a system comprising two or more reactors, at least one thereof being a hydrogen gas generator and another of said two or more reactors being a thermochemical decomposition reactor, wherein the hydrogen gas generator and the thermochemical decomposition reactor are in material and or thermal communication therebetween allowing transfer of heated hydrogen gas and/or a heated molten plastic mass (and thermal energy) from the hydrogen gas generator to the thermochemical decomposition reactor.

In another aspect, the invention provides a system for thermochemical recycling of plastic materials (e.g., for manufacturing distillates or fuel/petrochemicals from plastic waste), the system comprising at least two reactors, at least one of said reactors being a hydrogen gas generator and at least one other reactor being a thermochemical decomposition reactor, said at least one hydrogen gas generator is configured to receive a metal-rich waste plastic material from an external source, and wherein said thermochemical decomposition reactor is configured to receive a waste plastic material from an external source and a heated substantially metal-free mass and heated hydrogen gas and steam from the hydrogen gas generator.

The invention further provides a plant for actuating an integrated thermochemical process for conversion of plastic waste into high value products or generally products as disclosed herein, the plant comprising
a first reactor provided with first heaters for hydrotreating of a predominantly metal-rich plastic waste material and obtaining hydrogen gas, steam, heated plastic mass, gaseous products and metal oxides;
a second reactor with for thermochemical decomposition of a plastic waste materials, wherein the second reactor is provided with second heaters and is connected to the first reactor by at least one pipe to separately receive plastic waste material from an external feedstock or source and a quantity of the hydrogen gas, steam, heated plastic mass, gaseous products generated in the first reactor and obtaining the products;
a heat exchanger configured to receive heat from the first reactor and transfer the heat to the second reactor in order to recover within the process heat produced in the hydrotreating stage; and
an electrical control panel connected to said first and second heaters for at least adjusting the temperature of said hydrotreatment and thermochemical decomposition.

The integrated system and process allow for direct or indirect heat transfer between the exothermic (hydrogen production) and endothermic (thermochemical decomposition process) steps. As demonstrated in FIGS. 1A-C, the reactors forming systems of the invention may be integrated in various ways. The configuration depicted in FIGS. 1A and 1B demonstrate direct heat transfer between the hydrogen generator and the thermochemical reactor. In the system of FIG. 1A, the hydrogen gas generator (metal-H₂O reactor) is (materially and thermally) associated with the thermochemical reactor. The hydrogen gas generator is provided with a metal-rich waste material through a suitable inlet and is mixed with water introduced through the same (as a mixture of the metal-rich waste and water) or a different inlet. Under suitable hydrothermal conditions, as disclosed herein, heated hydrogen gas and steam are obtained along with a molten decomposed plastic mass. The hydrogen gas, steam, various gaseous products and the heated decomposed mass are flown from the hydrogen gas generator into the thermochemical decomposition reactor which is configured to separately receive plastic waste through a designated waste stream inlet. Metal oxide formed in the hydrogen gas generator may be separately separated from the reactor. Distillates as well as liquid and solid products which may form in the thermochemical reactor may be each separately collected.

In the further configuration depicted in FIG. 1B, the metal-rich waste material is pre-treated to separate the metallic components from the plastic materials. Alternatively, two separate material streams are used: a metal stream and a plastic stream. The system thus comprises a plastic waste material reactor and a separate hydrogen gas generator. The plastic waste material vessel is configured to receive and thermally treat the plastic waste to obtain a molten plastic, without substantially causing thermal decomposition of the plastic material. In the gas generator, metal is combined with water to generate hydrogen gas. Each of the hydrogen gas generator and the plastic waste material reactor are provided with an outlet to discharge hydrogen gas and molten polymer, respectively, directly into the thermochemical reactor that is configured to receive and hold a plastic waste material, as described herein.

In further configurations, the system may be equipped or provided with a heat transfer unit (operation is detailed in mass and energy balance) and a downstream system for fractional separation of produced vapors, as depicted in FIG. 1C. Heat recovery is achieved by passing the hydrogen-steam mixture (which may be obtained from the hydrogen gas generator of FIG. 1A or that of FIG. 1B) through a condensing heat exchanger shell. The hydrogen gas is separated from the shell and can further enable a hydrocracking reaction. Condensed water may be recovered and can be reused as make-up water for the hydrogen gas generator. Alternative heat recovery can be achieved by direct feeding of the hydrogen gas-steam mixture into the thermochemical decomposition reactor. The thermochemical decomposition reactor may be fed with plastic waste (plastic only waste and molten plastic from the hydrogen gas generator or plastic recovery system), gaseous materials and other liquid components.

In some embodiments, the hydrogen gas generator and the thermochemical decomposition reactor are individually addressed reactor units or vessels capable of receiving waste materials from different and optionally independent external sources. Each of the reactors is provided with an inlet valve(s) and an outlet valve(s) and means for associating the two reactors to permit flow of hydrogen gas and heated plastic mass (decomposed or not), typically a liquified mass, from the hydrogen gas reactor or separation vessel into the thermochemical decomposition reactor. Each of the reactor inlet valves are configured for permitting in-flow of materials into the reactor from an external unit, e.g., a waste source or reservoir, or from the other of the units, e.g., from the hydrogen generator into the thermochemical reactor. Similarly, the outlet valves are configured to output or dispense an amount (or a full vessel content) of a material, being in a gaseous, liquid or solid form, from the reactor into a different vessel or reservoir.

The hydrogen gas generator and the thermochemical reactor may be associated via a heated pipeline for flowing heated liquid polymer mass, gases and other byproducts from the hydrogen gas generator or the vessel purposed for converting a polymer waste material into a molten mass into the thermochemical decomposition reactor. Metal-rich waste material or separate metal (fresh feed and/or such recovered from a metal-plastic separator) can be fed as a solid or in a form of a dispersion in water through a pressurized feeder. Make up water can be fed through a high-pressure pump. The hydrogen gas generator containing metal and water may be provided with a top outlet for releasing hydrogen gas and steam extracted through a pressure control valve and a back pressure regulator, while the composition is affected by rate and ratio of metal and reactor conditions. Oxidized metal product may be withdrawn in a suspension through a throttling valve.

The hydrogen gas generator is a vessel or a reactor capable of operating at high pressures and temperatures, as disclosed herein. It is configured and sized to receive an amount of a metal-rich plastic waste and water, to permit or cause hydro-processing of the plastic waste in the presence of the metal to produce hydrogen gas, a heated liquified or decomposed plastic mass and other gaseous products. Metal oxide (e.g., alumina) depositions may also be collected as process byproducts.

The hydrogen gas, the heated mass and the metal oxides may be collected and stored for further use. Additionally or alternatively, the hydrogen gas and/or the heated mass may be transferred or flown into the thermochemical reactor as a clean energy source for driving the thermochemical decomposition. Thus, in some configurations, the hydrogen gas reactor or generator may be provided with an outlet for collecting the hydrogen gas.

The hydrogen gas generator may be associated with the thermochemical reactor by various means to permit flow of hydrogen gas, steam and other gaseous products and optionally a liquified plastic mass. Such means may be provided in a form of pipes optionally provided with heated pipe segments for allowing flow of plastic in a molten state; gas relief lines; a flow metering system; one or more high pressure dosing units; a hydrogen compressor; a thermal flow and level control and other units or elements.

Each of the reactors in a system of the invention may be fed by one or more waste streams. A metal-rich waste may be fed to a reactor where the metal is reacted with water/saturated steam/superheated steam, depending on the reaction conditions, according to the exothermic metal-water reaction set. Gaseous or liquid reaction products are used to transfer heat directly to or indirectly from the hydrogen-gas reactor or generator to the thermochemical decomposition reactor, depending on the reactor operating mode (isothermal/adiabatic) and the level of feedstock pretreatment. The heat and hydrogen required for the optimal thermochemical decomposition reaction conditions are recuperated from the integration with the hydrogen gas reactor.

The mixed plastic waste stream is fed into the thermochemical decomposition reactor where it is decomposed into a range of hydrocarbons. The hydrocarbons may include a separable mixture of gaseous and liquid products. In some embodiments, the products include a variety of distillates (e.g., jet fuel, naphtha) and petrochemicals, e.g., in an amount between 50 and 90% of the total amount of products, liquid petroleum materials and gases, e.g., in an amount between 10 and 50% of the total amount of products, and an amount of carbonaceous materials or ashes, e.g., in an amount that is less than 5% of the total amount of the products. These products may be separated from the reactor vessels via a products stream and further into various components or groups of components.

The metal-rich plastic waste may comprise a variety of metals in a variety of forms. A metal-rich plastic waste suitable for generating energy and hydrogen gas is such waste which comprises a zero valent form of a metal capable of reacting with water to evolve metal hydroxides or metal oxides as well as hydrogen gas, other gaseous materials and a liquified decomposed plastic mass. The metals present in the metal-rich waste may be calcium, aluminum, magnesium, zinc, and others. In some embodiments, the metal is aluminum. In some embodiments, the metal-rich plastic waste is an aluminum-rich plastic waste.

Typically, the metal-rich plastic waste, e.g., aluminum-rich plastic waste, is such a waste in which the metal is embedded or combined within the plastic material and is at times inseparable therefrom. The metal is typically not added to the waste; but combined in a plastic material. However, in some embodiments, low grade metal (such as used in metal containing packages or beverage cans, etc.) may be added as an additive to increase production capacity as well as a process stabilizer. The type of metal used and its amount may depend on a variety of factors, such as the amount of metal present in the metal-rich plastic waste.

In some embodiments, the metal is waste metal that may be sorted out of general waste and combined with plastic waste.

Typically, the amount of metal is at most 30% w/w of the metal containing stream, or may be further increased by the addition of low grade metal, e.g., aluminum. Thus, the amount may in some cases be at least 30% w/w.

The loading ratio of plastic:metal is typically between 3:1 and 15:1.

The plastic waste, unlike the metal-rich plastic waste, does not typically comprise metal in a zero-valent state. It may nevertheless contain metal salts or complexes or oxides.

The metal-rich plastic waste comprises an amount of a zero-valent metal that enables conversion of the water and metal into metal oxides and hydrogen gas accompanied by a release of steam, various gases and thermal energy. The plastic waste thus transforms into a liquid plastic mass and various gaseous materials that are typically metal-free or metal-poor. The “metal-free” or “metal-poor” or substantially metal-free waste or liquified mass is a plastic mass, typically in a liquid state that is deficient in zero-valent metal content as most of the metal is converted into its oxide, salt or complex form. Thus, while a metal-rich plastic waste may comprise an amount of a zero-valent metal, as defined and disclosed herein, the processed plastic waste or the plastic waste used in the thermochemical reactor may contain much smaller amounts of the zero-valent metal forms and may thus be regarded as free, poor or substantially free of the metal. In some embodiments, a substantially “metal-free” waste or mass may comprise no more than 10 wt % of zero-valent metal, or no more than 9, 8, 7, 6, 5, 4, 3, 2 or 1 wt %.

As noted herein, the metal-free plastic waste may be used sorted or unsorted. In some cases, the waste stream may contain an amount of polyvinylchloride (PVC), which presence in the waste may poison the hydrogen atmosphere with chloride gas. In such cases, the waste may be pretreated by melting, degassing and/or neutralizing the acidity caused by the emitted chlorine gas that will be converted into HCl in the hydrogen atmosphere. The neutralization may be achievable by scrubbing the vapor in water and producing HCl solution (as an additional byproduct), or in a caustic solution. Thus, in some embodiments, the waste streams are pretreated by melting the waste in an atmospheric pressure.

In some configurations, the plastic waste is derived from a municipal waste. The waste may comprise a single polymeric or plastic component or a combination of components such as polyethylene (such as low-density or high-density polyethylene) and polypropylene. In some embodiments, the waste may further comprise PVC, polystyrene and PET. In some embodiments, the plastic waste is free of PVC.

An exemplary waste combination may comprise low-density polyethylene (e.g., 23 wt %), high-density polyethylene (e.g., 19 wt %), polypropylene (e.g., 14 wt %), PVC (e.g., 6 wt %), polystyrene (e.g., 9 wt %) and PET (e.g., 10 wt %).

Additionally, the plastic waste material may be combined with a biomass.

The invention further provides a process for thermochemical recycling of plastic materials such as plastic waste (e.g., converting same into fuels and petrochemicals), the process comprising
hydrothermal liquification of a metal-rich plastic waste stream to produce hydrogen gas and a decomposed molten plastic mass and/or gaseous materials (e.g., produced through decomposition of the plastic mass); and
thermal decomposition of a plastic waste free of metals in the presence of the hydrogen gas and the molten plastic mass and/or gaseous materials;
to thereby generate the fuels and petrochemicals.

In some embodiments, the hydrogen gas production is achievable separately from the decomposed molten plastic mass or gaseous products evolved from the decomposition of the plastic mass.

The invention further provides a process comprising:
thermally reacting a metal-rich plastic waste and water to generate a metal-poor or metal-free molten plastic mass, gaseous materials and hydrogen gas;
transferring at least a portion of the metal-poor or metal-free plastic mass, and hydrogen gas to a thermochemical decomposition reactor containing or configured to receive metal-free plastic waste; and
reacting the combined metal-poor or metal-free plastic mass, hydrogen gas and metal-free plastic waste to produce fuels and petrochemicals.

Further provided is a continuous process for generating fuels and petrochemicals from plastic waste, the process comprising feeding at least two reactor vessels with plastic waste, wherein a first vessel is fed with plastic waste free of metallic components and wherein a second vessel is fed with a metal-rich plastic waste and water, under conditions allowing the metal in said metal-rich plastic waste to react with water to generate heat and hydrogen gas, transferring at least a portion of the hydrogen gas into the first vessel, under thermochemical conditions allowing generation of fuels and petrochemicals in the first vessel.

The water used in the hydrogen gas generator may be of any source. The water need not be clean or pure water. It may be sewage waters, tap water, sea water, salt-rich water, etc. When in operation, the reactor may contain the water in a liquid-vapor equilibrium or in a supercritical state. In some embodiments, the amount of water used in the hydrogen gas reactor or generator depends on the estimated amount of the metal present in the metal-rich waste. Typically, a ratio of metal:water of between 1:1 and 1:10 may be used.

In some embodiments, hydrogen gas is generated at elevated temperatures, e.g., a temperature between 27° and 450° C., and optionally under increased pressure, e.g., between 60 and 200 atm. In some embodiments, the temperature is between 30° and 400° C.

In some embodiments, generation of the fuels and petrochemicals occurs at elevated temperatures, e.g., between 20° and 400° C. and moderate pressures, e.g., between 10 and 70 atm. In some embodiments, the temperature is between 30° and 350° C.

In some embodiments, the process comprises feeding plastic waste into the vessels.

In some embodiments, the process comprises sorting waste to separate metal-containing plastic waste form metal-free plastic waste.

The invention further provides an integrated thermochemical process for the recovery of hydrogen gas and distillates from plastic waste comprising hydrocarbons and potentially biomass, the process comprising
a—feeding a quantity of a metal-rich plastic waste into a first reactor and treating said waste in the presence of water at a temperature maintained within a process value range between 270 and 450° C. for obtaining at least hydrogen gas and steam;
b—feeding a quantity of a plastic waste into a second reactor within a process value range between 20° and 400° C.; and
c—feeding into the second reactor an amount of said at least hydrogen gas and steam generated in the first reactor;
wherein steps a and b, or b and c occur concomitantly or sequentially.

In some embodiments, the process compromises providing a feedstock of at least one metal rich plastic waste material, wherein the feedstock is premixed with water or is fed into the first reactor containing water.

In some embodiments, the metal-rich plastic waste is provided as a feedstock of a metal waste and a feedstock of metal-free plastic waste, each being separately fed into a separate reactor. In some embodiments, a reactor fed with the metal waste comprises water to produce hydrogen gas and steam; and a reactor fed with said metal-free plastic waste is operable to produce molten plastic mass and gaseous products, wherein said hydrogen gas, steam, molten plastic mass and gaseous products are fed into the second reactor.

The invention further provides an integrated thermochemical process for providing an upgraded fuel and petrochemical composition from a plastic waste-derived feedstock, the process comprising
hydrotreating a metal-rich plastic waste feedstock through reaction with water to yield a hydrogen gas composition (comprising molten plastic mass, steam, gaseous products and metal oxide); and
thermochemically decomposition a plastic waste feedstock using the hydrogen gas composition, thereby generating the upgraded fuel and petrochemical composition.

Processes and systems of the invention do not comprise or involve external addition of hydrogen gas. All hydrogen gas utilized in processes of the invention are generated in situ in the hydrogen gas rector or generator, as defined. Additionally, all energy used in the thermochemical decomposition is generated in situ in the hydrogen generator and transferred into the thermochemical decomposition unit, as disclosed herein.

In some embodiments, processes of the invention are carried out on a system of the invention, as defined.

Processes of the invention operate thermally and do not require use of catalysts. However, catalysts may be used in any of the process steps to improve selectivity, yield and reduce operation temperatures. Plastic decomposition catalysts may be selected amongst zeolites and bifunctional hydrogenation/hydrocracking catalysts, such as zeolites and FCC. The amount of the catalyst may be smaller than 0.1 wt %.

In some cases, small amounts of NaOH may be additionally or alternatively used for catalyzing the hydrogen gas production in the hydrogen gas generator. The amount of the NaOH may be selected to strip off or remove oxide layer present on the metal component of the metal-rich waste, thereby pushing the hydrogen gas generation process forward. In addition to or in place of NaOH other caustic materials may be used. The amount of the caustic material or NaOH may be smaller than 0.1 wt % or at times between 0.1 and 5 wt %.

Products generated according to processes of the invention may be gaseous, liquid or solid products, referred to in general as fuels and petrochemicals, in amount ranges being 5 and 50 wt %. 5 and 50 wt % and 0 and 10 wt %, respectively. Byproducts such as metal oxides may also be generated. Gaseous products may include low carbon content products containing 1 to 4 carbon atoms and hydrogen gas. The liquid products may range from pyrolysis oils through hydrogenated pyrolysis oils distillates ranging from naphtha to jet fuel. Solid products can include heavy wax products and ash in inert environment pyrolysis or may be completely absent in the case of hydrocracking.

Thus, the fuels and petrochemical products produced by processes and systems of the invention may be any olefins, aromatics, paraffins, iso-paraffins, naphthenes, heavy hydrocarbons and others. The selection of products and their yields may depend on the decomposition process conditions, the heating rate, the feedstock composition and other process parameters.

The invention provides:

A system for thermochemical recycling of plastic materials, the system comprising
a first vessel (reactor) configured and operable for receiving a metal-rich plastic waste and hydrotreating the metal-rich plastic waste to produce hydrogen gas, a heated decomposed plastic mass and gaseous materials;
a second vessel (reactor) configured and operable for receiving a plastic waste and at least an amount of said hydrogen gas, and optionally the heated decomposed plastic mass and gaseous materials from the first vessel; and thermally decomposing the plastic waste in the presence of the hydrogen gas, and optionally the heated decomposed plastic mass and gaseous materials, to produce distillates; and
means to direct the hydrogen gas, and optionally the heated decomposed plastic mass and gaseous materials from the first vessel to the second vessel.

In some cases, the first vessel (reactor) is provided as two or more reactors, each configured to receive a different component of the metal-rich plastic waste.

In some cases, one of the two or more reactors is configured to receive and thermally convert plastic waste to a molten plastic and gaseous products; and another of the two or more reactors is configured to receive metal waste and water and configured to generate hydrogen gas.

In some cases, the second vessel is configured to receive a single stream of hydrogen gas and optionally also heated molten plastic and gaseous products; or a stream of a molten plastic and gaseous products and a separate stream of hydrogen gas and steam.

In some cases, the system comprising
a vessel (reactor) arrangement comprising two or more reactors, one of said two or more reactors being configured for receiving a metal-free plastic waste and thermally treating the metal-free plastic waste to produce a heated molten plastic mass and gaseous products; and a second of said two or more reactors being configured to receive a metal waste and hydrotreat the metal waste in the presence of water to generate hydrogen gas;
a second vessel (reactor) configured for receiving a plastic waste and thermally decomposing the plastic waste in the presence of the hydrogen gas, steam and optionally the heated molten plastic mass and gaseous products; and
means to direct the hydrogen gas and optionally the heated decomposed plastic mass and gaseous products from the first vessel arrangement to the second vessel.

In some cases, the system is associated with a metal-rich plastic waste stream configured to deliver a metal-rich plastic waste feedstock into the first vessel.

In some cases, the system is associated with two independent streams of metal and plastic wastes.

In some cases, the system is associated with a plastic waste stream configured to deliver a plastic waste feedstock into the second vessel.

In some cases, the system is configured for a continuous thermochemical conversion of a plastic waste into distillates.

Also provided is a system comprising two or more reactors, at least one thereof being a hydrogen gas generator and another of said two or more reactors being a thermochemical decomposition reactor, wherein the hydrogen gas generator and the thermochemical decomposition reactor are in material and or thermal communication therebetween allowing transfer of hydrogen gas and/or a molten plastic mass and gaseous products from the hydrogen gas generator to the thermochemical decomposition reactor.

In some cases, the system is equipped with a heat transfer unit and a downstream system for fractional separation of vapors.

In some cases, the hydrogen gas generator and the thermochemical reactor are associated via a heated pipeline.

In some cases, the plastic to metal loading ratio (plastic:metal) is between 3:1 and 15:1.

In some cases, the metal in the metal-rich plastic waste is aluminum.

A plant is provided for actuating an integrated thermochemical process for conversion of plastic waste into high value products, the plant comprising
a first reactor provided with first heaters for hydrotreating of a predominantly metal-rich plastic waste material and obtaining hydrogen gas, steam, heated plastic mass, gaseous products and metal oxides;
a second reactor for thermochemical decomposition of a plastic waste material, wherein the second reactor is provided with second heaters and is connected to the first reactor by at least one pipe to separately receive plastic waste material from an external feedstock or source and a quantity of the hydrogen gas, steam, heated plastic mass, gaseous products generated in the first reactor and obtaining the products; and
a heat exchange unit configured to receive heat from the first reactor and transfer the heat to the second reactor in order to recover within the process heat produced in the hydrotreating stage.

In some cases, the plant or system comprising an electrical control panel connected to said first and second heaters for at least adjusting the temperature of said hydrotreatment and thermochemical decomposition processes.

Also provided is a process for thermochemical recycling of plastic materials, the process comprising
hydrothermal liquification (or a metal water reaction) of a metal-rich plastic waste stream and water to produce hydrogen gas, steam, a heated molten plastic mass and gaseous products; and
thermal decomposition of a plastic waste free of metals in the presence of an amount of the hydrogen gas and optionally the steam, heated molten plastic mass and gaseous products;
wherein said hydrothermal liquification and thermal decomposition are carried out in separate vessels within a thermochemical system, to thereby generate fuels and petrochemicals.

In some cases, the hydrogen gas production is achievable separately from the generation of molten plastic mass and gaseous products.

A process is also provided for thermochemical recycling of plastic materials, the process comprising:
thermally reacting a metal-rich plastic waste and water to generate a metal-poor or metal-free molten plastic mass, gaseous products and hydrogen gas;
transferring at least a portion of the hydrogen gas and optionally of the metal-poor or metal-free plastic mass and gaseous products to a thermochemical decomposition reactor containing metal-free plastic waste; and
reacting the metal-free plastic waste at least in the presence of the hydrogen gas to produce fuels and petrochemicals.

In some cases, the water is sewage waters, tap water, sea water, or salt-rich water.

In some cases, a weight ratio of metal:water is between 1:1 and 1:10.

In some cases, the hydrogen gas is generated at a temperature between 27° and 450° C., and optionally under a pressure between 60 and 200 atm.

In some cases, the generation of the fuels and petrochemicals is at a temperature between 20° and 400° C. and a pressure between 10 and 70 atm.

An integrated thermochemical process is provided for the recovery of hydrogen gas and distillates from plastic waste comprising hydrocarbons and potentially biomass, the process comprising
a—feeding a quantity of a metal-rich plastic waste into a first reactor and treating said waste in the presence of water at a temperature maintained within a process value range between 27° and 450° C. for obtaining at least hydrogen gas and steam;
b—feeding a quantity of a plastic waste into a second reactor within a process value range between 20° and 400° C.; and
c—feeding into the second reactor an amount of said at least hydrogen gas and steam generated in the first reactor;
wherein steps a and b, or b and c occur concomitantly or sequentially.

In some cases, the process is carried out on a system according to the invention.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-C depict differ system designs according to the invention.

FIG. 2 depicts a system according to some embodiments of the invention.

FIG. 3 depicts a system and a process flow according to some embodiments of the invention.

FIG. 4 depicts an exemplary high level mass balance comparison of a proposed process versus a conventional process.

FIG. 5 shows a full life cycle analysis of GhG impact.

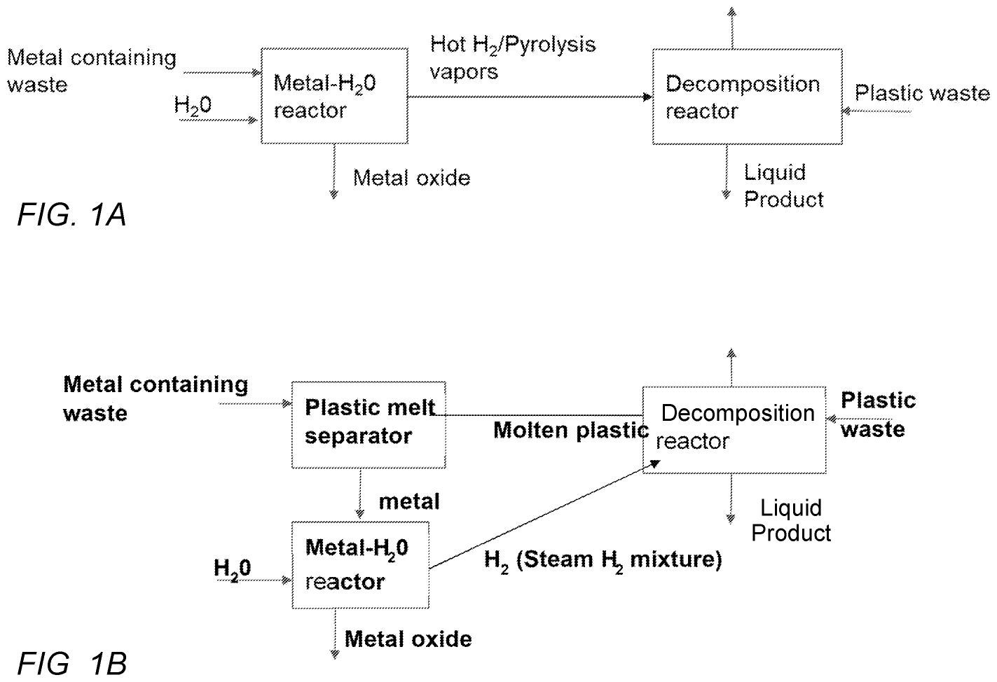

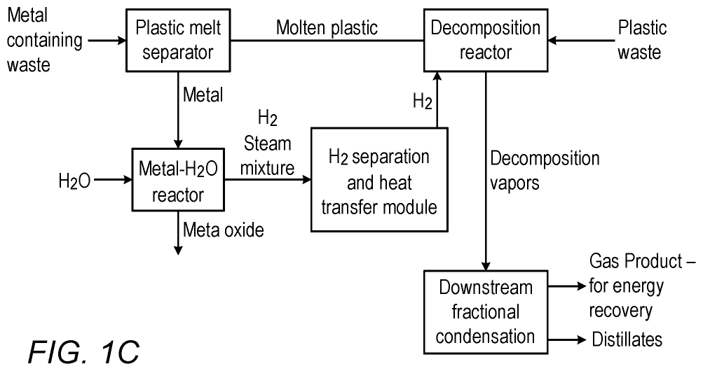

### DETAILED DESCRIPTION OF EMBODIMENTS

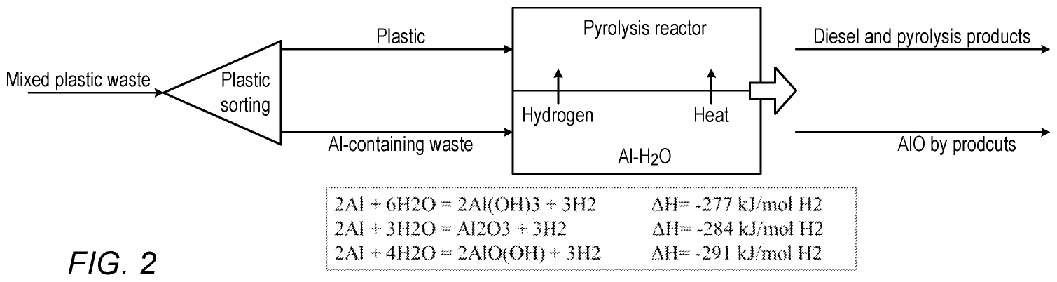

FIG. 2 depicts a system according to some embodiments of the invention. As shown, two reactors or vessels are provided in systems of the invention: a thermochemical decomposition reactor and a hydrogen gas reactor or generator (labeled in FIG. 2 as the Al—H₂O reactor). In the embodiment depicted in FIG. 2, the system is operated in presence of aluminum metal.

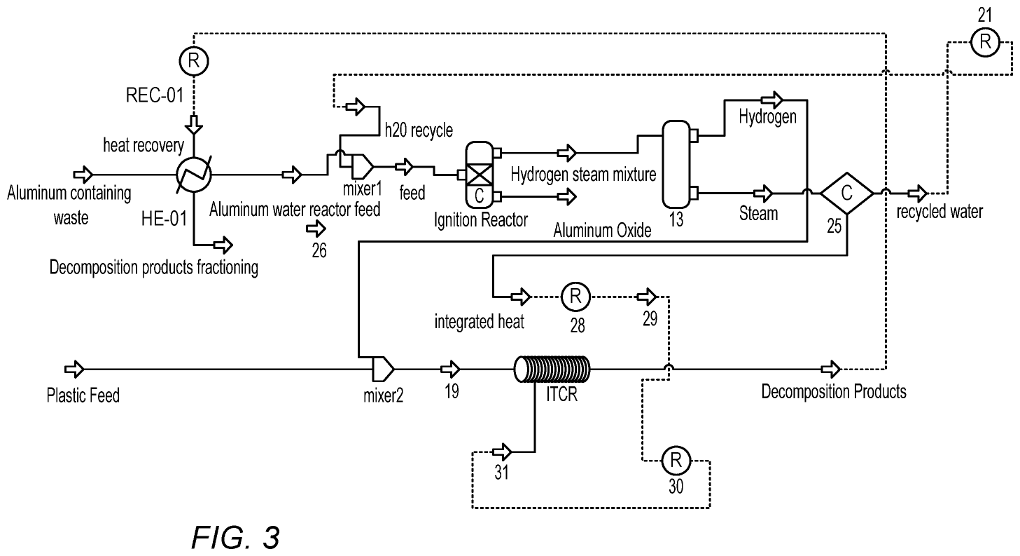

A possible system and process flow according to some embodiments of the invention is shown in FIG. 3.

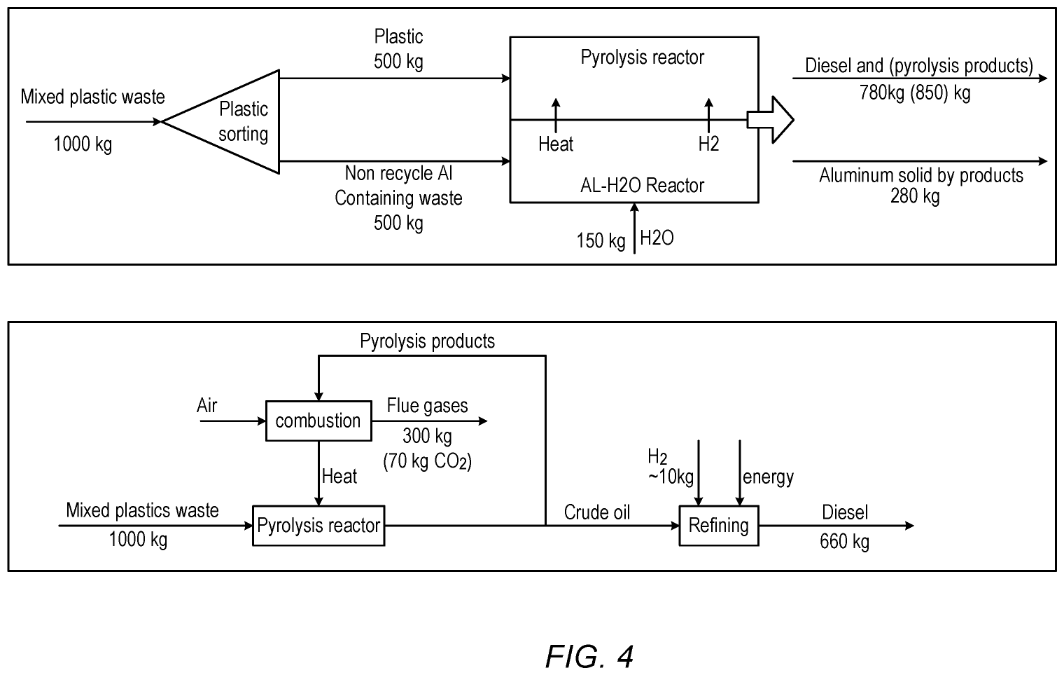

An exemplary high level mass balance comparison of the proposed process versus a conventional process is shown in FIG. 4 for a 1-ton mixed waste feed. Top panel in FIG. 4 shows a process according to the invention, while the bottom panel in FIG. 4 shows a conventional process.

As demonstrated in FIG. 4, by utilizing a system and process of the invention, for any tonnage amount of the plastic waste at least 10% more of the end products may be obtained. All necessary hydrogen gas can be obtained from aluminum-water reactions with excess of 20 kg/hr.

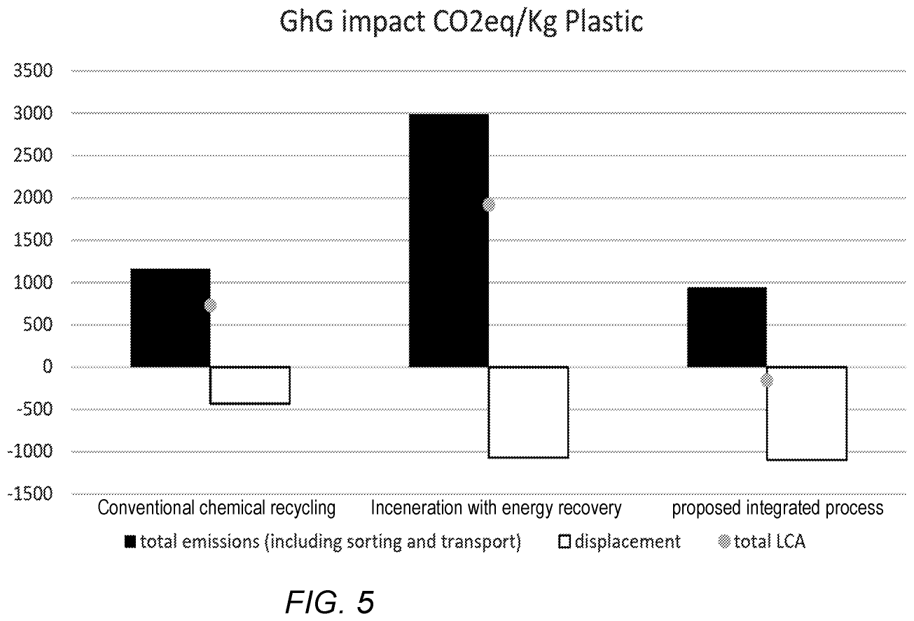

Also, 0.55 kg CO₂ can be displaced per kg distillates obtained from alumina recovered as a side product (metal oxide). This is further depicted in FIG. 5 showing a full life cycle analysis of GhG impact. Emissions include full life cycle (pretreatment and sorting) and are based on commercial data from a BASF chemical cycling process. Negative life cycle assessment (LCA) GhG impact results from the improvement in yield in addition to the displacement from alumina by-product recovery and hydrogen generation (1.2 and 8 to 12 Kg CO₂ g/kg Alumina and hydrogen respectively).

1. A system for thermochemical recycling of plastic materials, the system comprising
a first vessel (reactor) configured and operable for receiving a metal-rich plastic waste and hydrotreating the metal-rich plastic waste to produce hydrogen gas, a heated decomposed plastic mass and gaseous materials;
a second vessel (reactor) configured and operable for receiving a plastic waste and at least an amount of said hydrogen gas, and optionally the heated decomposed plastic mass and gaseous materials from the first vessel; and thermally decomposing the plastic waste in the presence of the hydrogen gas, and optionally the heated decomposed plastic mass and gaseous materials, to produce distillates; and
means to direct the hydrogen gas, and optionally the heated decomposed plastic mass and gaseous materials from the first vessel to the second vessel.

2. The system according to claim 1, wherein the first vessel (reactor) is provided as two or more reactors, each configured to receive a different component of the metal-rich plastic waste.

3. The system according to claim 2, wherein one of the two or more reactors is configured to receive and thermally convert plastic waste to a molten plastic and gaseous products; and another of the two or more reactors is configured to receive metal waste and water and configured to generate hydrogen gas.

4. The system according to any one of claims 1 to 3, wherein the second vessel is configured to receive a single stream of hydrogen gas and optionally also heated molten plastic and gaseous products; or a stream of a molten plastic and gaseous products and a separate stream of hydrogen gas and steam.

5. The system according to claim 1, the system comprising
a vessel (reactor) arrangement comprising two or more reactors, one of said two or more reactors being configured for receiving a metal-free plastic waste and thermally treating the metal-free plastic waste to produce a heated molten plastic mass and gaseous products; and a second of said two or more reactors being configured to receive a metal waste and hydrotreat the metal waste in the presence of water to generate hydrogen gas;
a second vessel (reactor) configured for receiving a plastic waste and thermally decomposing the plastic waste in the presence of the hydrogen gas, steam and optionally the heated molten plastic mass and gaseous products; and
means to direct the hydrogen gas and optionally the heated decomposed plastic mass and gaseous products from the first vessel arrangement to the second vessel.

6. The system according to claim 1, the system being associated with a metal-rich plastic waste stream configured to deliver a metal-rich plastic waste feedstock into the first vessel.

7. The system according to claim 1, the system being associated with two independent streams of metal and plastic wastes.

8. The system according to claim 1, the system being associated with a plastic waste stream configured to deliver a plastic waste feedstock into the second vessel.

9. The system according to any one of the preceding claims, being configured for a continuous thermochemical conversion of a plastic waste into distillates.

10. A system comprising two or more reactors, at least one thereof being a hydrogen gas generator and another of said two or more reactors being a thermochemical decomposition reactor, wherein the hydrogen gas generator and the thermochemical decomposition reactor are in material and or thermal communication therebetween allowing transfer of hydrogen gas and/or a molten plastic mass and gaseous products from the hydrogen gas generator to the thermochemical decomposition reactor.

11. The system according to any one of the preceding claims, further equipped with a heat transfer unit and a downstream system for fractional separation of vapors.

12. The system according to any one of the preceding claims, wherein the hydrogen gas generator and the thermochemical reactor are associated via a heated pipeline.

13. The system according to any one of the preceding claims, wherein the plastic to metal loading ratio (plastic:metal) is between 3:1 and 15:1.

14. The system according to any one of the preceding claims, wherein the metal in metal-rich plastic waste is aluminum.

15. A plant for actuating an integrated thermochemical process for conversion of plastic waste into high value products, the plant comprising
a first reactor provided with first heaters for hydrotreating of a predominantly metal-rich plastic waste material and obtaining hydrogen gas, steam, heated plastic mass, gaseous products and metal oxides;
a second reactor for thermochemical decomposition of a plastic waste material, wherein the second reactor is provided with second heaters and is connected to the first reactor by at least one pipe to separately receive plastic waste material from an external feedstock or source and a quantity of the hydrogen gas, steam, heated plastic mass, gaseous products generated in the first reactor and obtaining the products; and
a heat exchange unit configured to receive heat from the first reactor and transfer the heat to the second reactor in order to recover within the process heat produced in the hydrotreating stage.

16. The system according to any one of the preceding claims, comprising an electrical control panel connected to said first and second heaters for at least adjusting the temperature of said hydrotreatment and thermochemical decomposition processes.

17. A process for thermochemical recycling of plastic materials, the process comprising
hydrothermal liquification (or a metal water reaction) of a metal-rich plastic waste stream and water to produce hydrogen gas, steam, a heated molten plastic mass and gaseous products; and
thermal decomposition of a plastic waste free of metals in the presence of an amount of the hydrogen gas and optionally the steam, heated molten plastic mass and gaseous products;
wherein said hydrothermal liquification and thermal decomposition are carried out in separate vessels within a thermochemical system, to thereby generate fuels and petrochemicals.

18. The process according to claim 17, wherein the hydrogen gas production is achievable separately from the generation of molten plastic mass and gaseous products.

19. A process for thermochemical recycling of plastic materials, the process comprising:
thermally reacting a metal-rich plastic waste and water to generate a metal-poor or metal-free molten plastic mass, gaseous products and hydrogen gas;
transferring at least a portion of the hydrogen gas and optionally of the metal-poor or metal-free plastic mass and gaseous products to a thermochemical decomposition reactor containing metal-free plastic waste; and
reacting the metal-free plastic waste at least in the presence of the hydrogen gas to produce fuels and petrochemicals.

20. The process according to any one of claims 17 to 19, wherein the water is sewage waters, tap water, sea water, or salt-rich water.

21. The process according to any one of claims 17 to 20, wherein a weight ratio of metal:water is between 1:1 and 1:10.

22. The process according to any one of claims 17 to 21, wherein hydrogen gas is generated at a temperature between 270 and 450° C., and optionally under a pressure between 60 and 200 atm.

23. The process according to any one of claims 17 to 22, wherein generation of the fuels and petrochemicals is at a temperature between 20° and 400° C. and a pressure between 10 and 70 atm.

24. An integrated thermochemical process for the recovery of hydrogen gas and distillates from plastic waste comprising hydrocarbons and potentially biomass, the process comprising
a—feeding a quantity of a metal-rich plastic waste into a first reactor and treating said waste in the presence of water at a temperature maintained within a process value range between 27° and 450° C. for obtaining at least hydrogen gas and steam;
b—feeding a quantity of a plastic waste into a second reactor within a process value range between 20° and 400° C.; and
c—feeding into the second reactor an amount of said at least hydrogen gas and steam generated in the first reactor;
wherein steps a and b, or b and c occur concomitantly or sequentially.

25. The process according to any one of claims 17 to 24, carried out on a system according to any one of claims 1 to 16.
